(19) United States
(12) Patent Application Publication
(10) Pub. No.: US 2025/0381910 A1
(43) Pub. Date: Dec. 18, 2025

(54) VEHICLE LAMP SYSTEM

(71) Applicant: Ford Global Technologies, LLC, Dearborn, MI (US)

(72) Inventors: Michael Robertson, JR., West Bloomfield, MI (US); Aaron Bradley Johnson, Allen Park, MI (US); Venkatesh Krishnan, Canton, MI (US); Segundo Baldovino, Novi, MI (US)

(73) Assignee: Ford Global Technologies, LLC, Dearborn, MI (US)

(21) Appl. No.: 18/746,598

(22) Filed: Jun. 18, 2024

(51) Int. Cl. B60Q 1/44; B60Q 1/50; H05B 47/105; H05B 47/155

(52) U.S. Cl. CPC B60Q 1/444; B60Q 1/507; H05B 47/105; H05B 47/155; B60Q 2400/20; B60Q 2800/10

(57) ABSTRACT

A computer includes a processor and a memory, and the memory stores instructions executable by the processor to receive an input from an operator of a vehicle, the input setting a parameter for a shifting lighting pattern of a lamp of the vehicle, the shifting lighting pattern including cycling through a plurality of colors including a first color; in response to a speed at which the vehicle is traveling exceeding a speed threshold and the vehicle being in an autonomous mode, actuate the lamp to continuously emit the first color; and in response to the speed at which the vehicle is traveling being below the threshold speed, actuate the lamp to emit light following the shifting lighting pattern according to the inputted parameter.

### BACKGROUND

Vehicles may be provided with various lamps, including headlamps, brake lamps, and turn indicators. The headlamps are generally fixed relative to the vehicle and disposed at a front of the vehicle facing in a vehicle-forward direction. Types of lighting systems used for the headlamps include tungsten, halogen, high-intensity discharge (HID) such as xenon, light-emitting diode (LED), laser, etc. Brake lamps are fixed relative to the vehicle and disposed at a rear end of the vehicle facing in a vehicle-rearward direction. Brake lamps illuminate red. Turn indicators are generally located at corners of the vehicle and equipped to blink.

### BRIEF DESCRIPTION OF THE DRAWINGS

FIG. 1 is a block diagram of an example vehicle.

FIG. 2 is a perspective view of the example vehicle.

FIG. 3 is a plan view of an example lamp unit of the vehicle.

FIG. 4 is a cross-sectional perspective view of the lamp unit.

FIG. 5 is a flowchart of an example process for actuating the lamp unit.

### DETAILED DESCRIPTION

This disclosure pertains to a lamp system for a vehicle. The lamp system can convey information about the vehicle to other vehicles and road users, namely speed and autonomous mode, while also accommodating customization by the operator of the vehicle. A computer of the vehicle is programmed to, in response to a speed at which the vehicle is traveling exceeding a speed threshold and the vehicle being in an autonomous mode, actuate the lamp to continuously emit a first color, e.g., turquoise. The computer is further programmed to, in response to the speed at which the vehicle is traveling being below the threshold speed, actuate the lamp to emit light following a shifting lighting pattern according to a parameter. The shifting lighting pattern cycles through a plurality of colors including the first color, e.g., purple, white, and turquoise. The parameter may be, e.g., another one of the plurality of colors or a time duration to fade between different colors. The computer is programmed to receive an input from the operator setting the parameter, thereby permitting customization. The inclusion of the first color can indicate to others that the vehicle is capable of autonomous operation, and the parameter allows customization by the operator, meaning that the use of the shifting lighting pattern allows the lamp system to both convey information and accommodate the customization.

A computer includes a processor and a memory, and the memory stores instructions executable by the processor to receive an input from an operator of a vehicle, the input setting a parameter for a shifting lighting pattern of a lamp of the vehicle, the shifting lighting pattern including cycling through a plurality of colors including a first color; in response to a speed at which the vehicle is traveling exceeding a speed threshold and the vehicle being in an autonomous mode, actuate the lamp to continuously emit the first color; and in response to the speed at which the vehicle is traveling being below the threshold speed, actuate the lamp to emit light following the shifting lighting pattern according to the inputted parameter.

In an example, the plurality of colors of the shifting lighting pattern may include a second color, and the inputted parameter may be a selection of the second color.

In an example, the shifting lighting pattern may include fading between colors of the plurality of colors in a sequence, and the inputted parameter may be a time duration of the fading between consecutive colors of the sequence.

In an example, the shifting lighting pattern may include repeating a sequence of the plurality of the colors, and a time duration to emit the first color may be longer than a time duration to emit a second color of the plurality of colors. In a further example, the time duration to emit the first color may be longer than any time duration of any other color of the plurality of colors.

In an example, the instructions may further include instructions to, in response to the vehicle decelerating and the speed at which the vehicle is traveling being within a threshold difference of the speed threshold, actuate the lamp to emit light following a strobe lighting pattern. In a further example, the strobe lighting pattern may include repeatedly actuating the lamp on and off. In a yet further example, a rate of actuating the lamp on and off in the strobe lighting pattern may be faster than a rate of switching colors in the shifting lighting pattern.

In an example, the instructions may further include instructions to, in response to the vehicle shifting into park, actuate the lamp to emit light following a first lighting pattern, the first lighting pattern being different than the shifting lighting pattern and different than continuously emitting the first color.

In an example, the instructions may further include instructions to, in response to one of braking or an active turn indicator of the vehicle, actuate the lamp to indicate the braking or the active turn indicator. In a further example, actuating the lamp to indicate the braking or the active turn indicator may override the shifting lighting pattern.

In an example, the instructions may further include instructions to, in response to the vehicle being in a nonautonomous mode, actuate the lamp to emit light following a first lighting pattern, the first lighting pattern being different than the shifting lighting pattern and different than continuously emitting the first color.

In an example, the lamp may be a first lamp, and the instructions may further include instructions to, in response to one of braking or an active turn indicator of the vehicle, actuate a second lamp to indicate the braking or the active turn indicator, the second lamp being in a same housing as the first lamp. In a further example, the instructions may further include instructions to, in response to an absence of the one of the braking or the active turn indicator of the vehicle, actuate the second lamp following a same pattern as the first lamp.

In an example, the first color may be turquoise.

A method includes receiving an input from an operator of a vehicle, the input setting a parameter for a shifting lighting pattern of a lamp of the vehicle, the shifting lighting pattern including cycling through a plurality of colors including a first color; in response to a speed at which the vehicle is traveling exceeding a speed threshold and the vehicle being in an autonomous mode, actuating the lamp to continuously emit the first color; and in response to the speed at which the vehicle is traveling being below the threshold speed, actuating the lamp to emit light following the shifting lighting pattern according to the inputted parameter.

In an example, the plurality of colors of the shifting lighting pattern may include a second color, and the inputted parameter is a selection of the second color.

In an example, the shifting lighting pattern may include fading between consecutive colors of the plurality of colors, and the inputted parameter may be a time duration of the fading between consecutive colors.

In an example, the shifting lighting pattern may include repeating a sequence of the plurality of the colors, and a time duration to emit the first color may be longer than a time duration to emit a second color of the plurality of colors.

In an example, the lamp may be a first lamp, and the method may further include, in response to one of braking or an active turn indicator of the vehicle, actuating a second lamp to indicate the braking or the active turn indicator, the second lamp being in a same housing as the first lamp; and in response to an absence of the one of the braking or the active turn indicator of the vehicle, actuating the second lamp following a same pattern as the first lamp.

With reference to the Figures, wherein like numerals indicate like parts throughout the several views, a computer 105 includes a processor and a memory, and the memory stores instructions executable by the processor to receive an input from an operator of a vehicle 100, the input setting a parameter for a shifting lighting pattern of a first lamp 110 of the vehicle 100, the shifting lighting pattern including cycling through a plurality of colors including a first color; in response to a speed at which the vehicle 100 is traveling exceeding a speed threshold and the vehicle 100 being in an autonomous mode, actuate the first lamp 110 to continuously emit the first color; and in response to the speed at which the vehicle 100 is traveling being below the threshold speed, actuate the first lamp 110 to emit light following the shifting lighting pattern according to the inputted parameter.

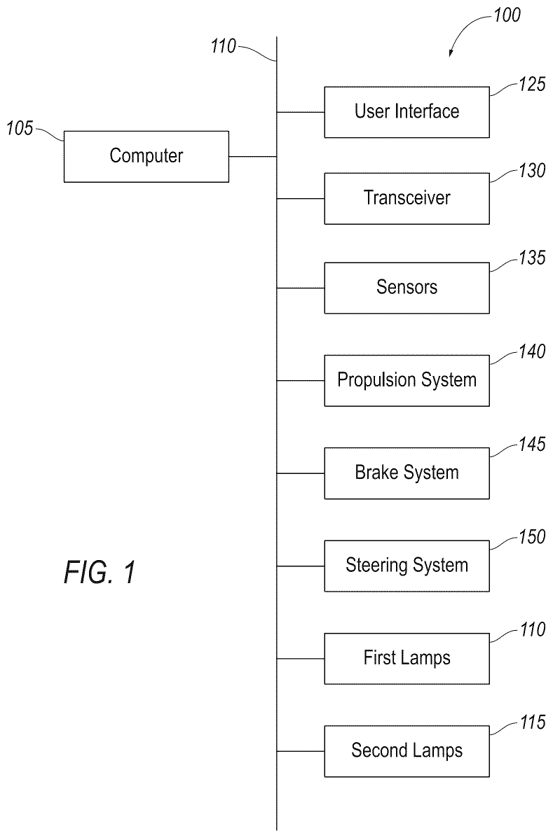

With reference to FIG. 1, the vehicle 100 may be any passenger or commercial automobile such as a car, a truck, a sport utility vehicle, a crossover, a van, a minivan, a taxi, a bus, etc. The vehicle 100 includes the computer 105, a communications network 120, a user interface 125, a transceiver 130, sensors 135, a propulsion system 140, a brake system 145, a steering system 150, at least one first lamp 110, and at least one second lamp 115.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 120. The communications network 120 may be, e.g., a controller area network (CAN) bus, Ethernet, WiFi, Local Interconnect Network (LIN), onboard diagnostics connector (OBD-II), and/or any other wired or wireless communications network. The computer 105 may be communicatively coupled to the user interface 125, the transceiver 130, the sensors 135, the propulsion system 140, the brake system 145, the steering system 150, the first lamps 110, the second lamps 115, and other components via the communications network 120.

The user interface 125 presents information to and receives information from an operator of the vehicle 100. The user interface 125 may be located, e.g., on an instrument panel in a passenger compartment of the vehicle 100, or wherever may be readily seen by the operator. The user interface 125 may include dials, digital readouts, screens, speakers, and so on for providing information to the operator, e.g., human-machine interface (HMI) elements such as are known. The user interface 125 may include buttons, knobs, keypads, microphone, and so on for receiving information from the operator.

The transceiver 130 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 130 may be adapted to communicate with a remote server, that is, a server distinct and spaced from the vehicle 100. The remote server may be located outside the vehicle 100. For example, the remote server may be associated with another vehicle (e.g., V2V communications), an infrastructure component (e.g., V2I communications), a first responder, a mobile device associated with the operator of the vehicle 100, etc. The transceiver 130 may be one device or may include a separate transmitter and receiver.

The sensors 135 may provide data about operation of the vehicle 100, for example, wheel speed, wheel orientation, and engine and transmission data (e.g., temperature, fuel consumption, etc.). For example, the sensors 135 may include a speedometer. The speedometer may be any sensor suitable for measuring the speed of the vehicle 100, for example, as is known, a mechanical or eddy-current speedometer, or a vehicle speed sensor. A vehicle speed sensor may use a magnetic field detector to count interruptions of a magnetic field by a toothed metal disk disposed on a driveshaft of the vehicle 100. The sensors 135 may detect the location and/or orientation of the vehicle 100. For example, the sensors 135 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 135 may detect the external world, e.g., objects and/or characteristics of surroundings of the vehicle 100, such as other vehicles, road lane markings, traffic lights and/or signs, road users, etc. For example, the sensors 135 may include radar sensors, ultrasonic sensors, scanning laser range finders, light detection and ranging (lidar) devices, and image processing sensors such as cameras.

The propulsion system 140 of the vehicle 100 generates energy and translates the energy into motion of the vehicle 100. The propulsion system 140 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 140 can include an electronic control unit (ECU) or the like that is in communication with and receives input from the computer 105 and/or a human operator. The human operator may control the propulsion system 140 via, e.g., an accelerator pedal and/or a gear-shift lever.

The brake system 145 is typically a conventional vehicle braking subsystem and resists the motion of the vehicle 100 to thereby slow and/or stop the vehicle 100. The brake system 145 may include friction brakes such as disc brakes, drum brakes, band brakes, etc.; regenerative brakes; any other suitable type of brakes; or a combination. The brake system 145 can include an electronic control unit (ECU) or the like that is in communication with and receives input from the computer 105 and/or a human operator. The human operator may control the brake system 145 via, e.g., a brake pedal.

The steering system 150 is typically a conventional vehicle steering subsystem and controls the turning of the wheels. The steering system 150 may be a rack-and-pinion system with electric power-assisted steering, a steer-by-wire system, as both are known, or any other suitable system. The steering system 150 can include an electronic control unit (ECU) or the like that is in communication with and receives input from the computer 105 and/or a human operator. The human operator may control the steering system 150 via, e.g., a steering wheel.

The vehicle 100 may be an autonomous vehicle. A vehicle computer can be programmed to operate the vehicle 100 independently of the intervention of a human operator, completely or to a lesser degree. The vehicle computer may be programmed to operate the propulsion system 140, the brake system 145, the steering system 150, and/or other vehicle systems. For the purposes of this disclosure, an autonomous mode means the vehicle computer controls the propulsion system 140, brake system 145, and steering system 150 without needing input from a human operator (although the human operator may need be prepared to take over control of the vehicle 100); and a nonautonomous mode means that a human operator is actively controlling at least one of the propulsion system 140, brake system 145, and steering system 150. The vehicle computer may be the same as the computer 105 or may transmit an indication that the vehicle 100 is operating in the autonomous mode or nonautonomous mode to the computer 105.

The first lamps 110 and the second lamps 115 are equipped to emit light in different colors and according to different lighting patterns, as will be described below. The computer 105 may transmit instructions via the communications network 120 actuating the lamps 110, 115 to emit a specific color, to not emit light (i.e., to turn off), or to fade from one color to another color.

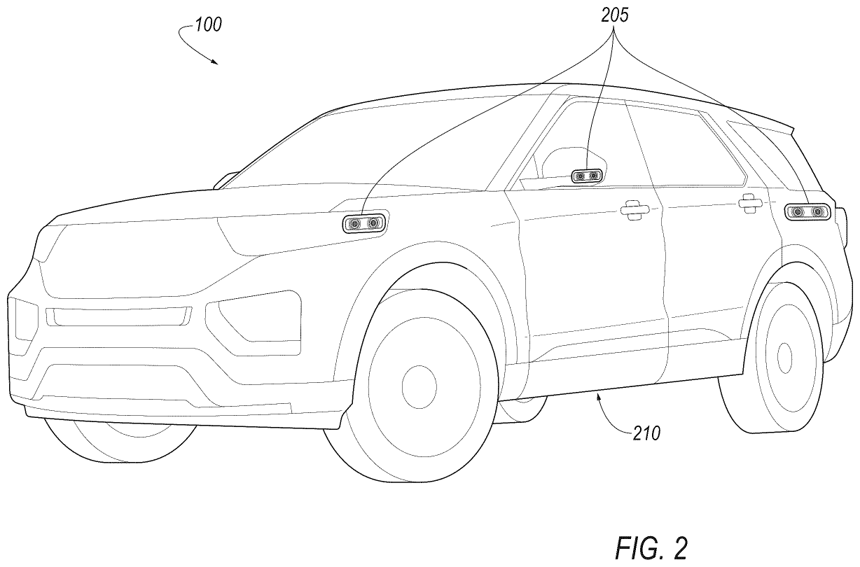

With reference to FIG. 2, the vehicle 100 includes at least one lamp unit 205, e.g., a plurality of lamp units 205. As will be described below, each lamp unit 205 may include one first lamp 110 and one second lamp 115. The lamp units 205 may be mounted to a body 210 of the vehicle 100 at different locations. For example, a lamp unit 205 may be mounted adjacent to a headlamp, on a side-view mirror assembly, or adjacent to a brake lamp of the vehicle 100, as shown in FIG. 2.

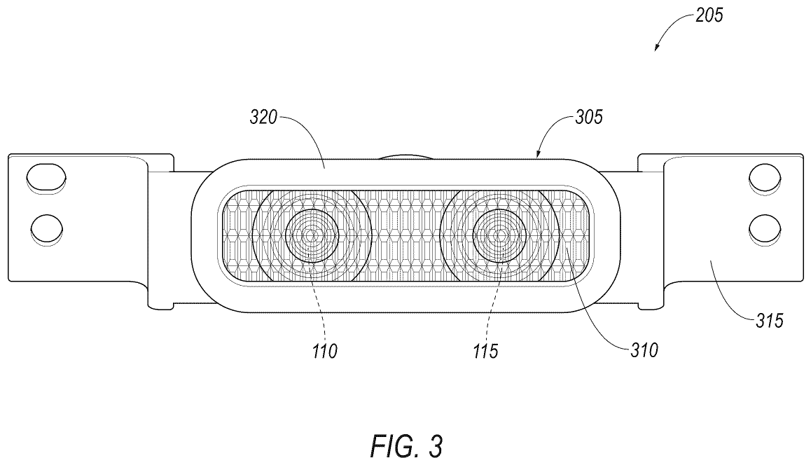

With reference to FIG. 3, each lamp unit 205 may include the first lamp 110 and the second lamp 115. The lamp unit 205 may include a housing 305. The first lamp 110 and the second lamp 115 may be located in the same housing 305. The first lamp 110 and the second lamp 115 may be spaced from each other and adjacent to each other, i.e., without any intervening lamps. The first lamp 110 and the second lamp 115 may be positioned to emit light through a same outer lens 310.

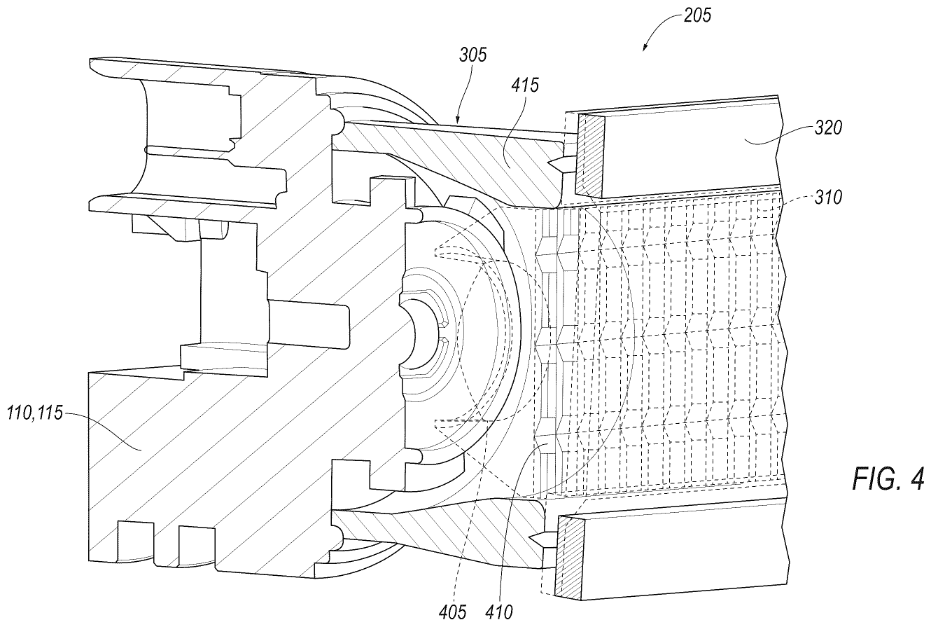

With reference to FIG. 4, each lamp unit 205 may include the housing 305, the lamps 110, 115, and one or more lenses 310, 405, 410. The housing 305 supports the lamps 110, 115 and protects the lamps 110, 115 from an exterior environment. The lenses 310, 405, 410 direct the light emitted by the lamps 110, 115 and may also protect the lamps 110, 115 from the exterior environment. The structure shown in FIG. 4 is applicable to both the first lamp 110 and the second lamp 115.

The lamps 110, 115 may be any suitable type for emitting multiple colors. For example, the lamps 110, 115 may be red-green-blue (RGB) light-emitting diodes (LEDs). An LED is a semiconductor device that emits electromagnetic radiation when electrical current flows through it, via the phenomenon of electroluminescence. An LED includes a leadframe with an anvil and post (not shown). The leadframe is connected to anode and cathode pins. The anvil includes a semiconductor die that produces the electromagnetic radiation inside a reflective cavity. The leadframe may be housed in an epoxy lens or case. An LED may emit electromagnetic radiation at a wavelength defined by the construction and/or material of the semiconductor die. The RGB LEDs can mix different brightnesses of red, green, and blue in order to emit other colors, e.g., by using three different LED bulbs, one each for red, green, and blue.

The lenses 310, 405, 410 may include a near-field lens 405, an optical lens 410, and the outer lens 310. The near-field lens 405 may distribute the light emitted by the lamp 110, 115 to a specified area of the optical lens 410, i.e., serve as a projector. The near-field lens 405 may be rigidly mounted onto the lamp 110, 115. The optical lens 410 may scatter the light in many directions so that the illumination is visible across a wide angle relative to the lamp unit 205. The outer lens 310 may permit the light to pass through while protecting the optical lens 410 and other interior components. The lenses 310, 405, 410 may be fixed relative to one another, e.g., by the housing 305.

The housing 305 may include multiple components rigidly attached together. For example, the housing 305 may include a bracket 315 (shown in FIG. 3), a connecting tunnel 415, and a bezel 320. The bracket 315 may mount the lamp unit 205 to the body 210 of the vehicle 100. In lieu of the near-field lens 405, the bracket 315 may include a reflector around the lamps 110, 115 to reflect the light emitted by the lamps 110, 115 toward the optical lens 410. The lamps 110, 115 may be mounted to the bracket 315. The connecting tunnel 415 may attach the bezel 320, optical lens 410, and outer lens 310 to the lamp 110, 115 and to the bracket 315. The bezel 320 may hold the optical lens 410 and outer lens 310 in place against the connecting tunnel 415.

The lamp units 205 may include other techniques for producing and emitting multiple colors. For example, the lamp unit 205 may include a light pipe instead of the optical lens 410 and outer lens 310. A light pipe is an optical fiber or solid transparent plastic rod for distributing light along its length. The light pipe may extend along, e.g., an outer trim element of the vehicle 100. For another example, quantum dots may be embedded in the near-field lens 405 or light pipe or embedded in a film applied to the near-field lens 405 or light pipe. The quantum dots emit visible light at a specific wavelength when illuminated by ultraviolet light. Together with the quantum dots, the lamps 110, 115 may be ultraviolet LEDs having wavelengths corresponding to activation wavelengths of the quantum dots.

Returning to FIG. 3, the computer 105 is programmed to actuate the lamps 110, 115 to follow lighting patterns. For the purposes of this disclosure, a “lighting pattern” is defined as an output of a lamp 110, 115 as a function of time according to a prestored program. For example, a lighting pattern may be a vector-valued function of time, in which each entry of the vector represents a color, e.g., as in the following expression:

$$C ( t ) = 〈 r ( t ) , g ( t ) , b ( t ) 〉$$

in which C is a vector, r is a quantity of the color red, g is a quantity of the color green, and b is a quantity of the color blue. The colors r, g, b may be on, e.g., an 8-bit scale (0 to 255) or a 12- or 16-bit scale. Each lighting pattern may have a time interval over which the lighting pattern is defined, and the lighting pattern may repeat at each time interval. This repetition may be defined mathematically as the time t being a remainder of a current time divided by the time interval. The computer 105 may actuate the first lamp 110 and the second lamp 115 to follow the same lighting pattern or different lighting patterns, depending on circumstances described below.

The computer 105 stores a plurality of the lighting patterns in memory. For example, the computer 105 may store a solid lighting pattern, a shifting lighting pattern, a nonautonomous lighting pattern, a welcome lighting pattern, a strobe lighting pattern, and signal lighting patterns, which will each be described in turn further below.

The lighting patterns each include one or a plurality of colors. Multiple lighting patterns include at least a first color that is the same in each of the lighting patterns. The first color may be chosen to indicate that the vehicle 100 is in an autonomous mode or is capable of an autonomous mode. For example, the first color may be turquoise. The first color may be generated by a component of the lamp 110, 115 that is capable of directly generating the first color or may be generated as a combination of primary colors, e.g., red, green, and blue.

The different lighting patterns have corresponding triggers. The computer 105 is programmed to actuate the lamp 110, 115 to follow a specific lighting pattern in response to the trigger for that lighting pattern being satisfied. The trigger is made of one or more conditions that must be satisfied for the trigger to be satisfied. The conditions may represent aspects of a state of the vehicle 100, e.g., the speed at which the vehicle 100 is traveling, an acceleration of the vehicle 100, the autonomous or nonautonomous mode of the vehicle 100, a gear that the propulsion system 140 of the vehicle 100 is in, etc.

The different lighting patterns have different parameters that define the lighting patterns. Each parameter quantifies some aspect of the lighting pattern, e.g., colors to include in the lighting pattern, rates of switching colors in the lighting pattern, durations to fade between colors in the lighting pattern, etc.

The computer 105 is programmed to receive inputs from the operator of the vehicle 100. The inputs set respective parameters for one or more of the lighting patterns. For example, an input from the operator may set a parameter for the shifting lighting pattern, e.g., a choice of a color or a time duration of fading between consecutive colors (described below). The computer 105 may receive the inputs via the user interface 125 or via the transceiver 130. For example, the operator may navigate a menu structure displayed on the user interface 125 to select from options for different parameters. The options may be different possible values available for the parameter, e.g., purple, green, etc. as possible values for a color included in the lighting pattern, or fast, medium, or slow for the time duration of fading between consecutive colors. For another example, the operator may navigate an app installed on a mobile device, and the mobile device may transmit the input to the computer 105 via the transceiver 130.

The computer 105 is programmed to actuate the lamp 110, 115 to emit light following the solid lighting pattern. The solid lighting pattern may be to actuate the lamp 110, 115 to continuously emit a single color, e.g., without brightness variations, e.g., C=C₁, in which C₁ is a constant vector representing the single color. For example, the color may be the first color, i.e., the color indicating autonomous operation, e.g., turquoise. The solid pattern may lack parameters that are changeable by input from the operator.

The trigger for the solid lighting pattern may be that the speed at which the vehicle 100 is traveling exceeds a speed threshold and that the vehicle 100 is in an autonomous mode. In other words, the computer 105 is programmed to, in response to the speed at which the vehicle 100 is traveling exceeding the speed threshold and the vehicle 100 being in the autonomous mode, actuate the lamp 110, 115 to continuously emit the first color. The computer 105 may receive the speed at which the vehicle 100 is traveling from a speedometer of the sensors 135. The speed threshold may be chosen to separate residential streets or streets with similarly slow posted speeds from roads with faster posted speeds, e.g., a speed threshold of 25 miles per hour.

The computer 105 is programmed to actuate the lamp 110, 115 to emit light following the shifting lighting pattern. The shifting lighting pattern includes cycling through a plurality of colors including the first color, e.g., for four colors, each cycle is a sequence of C₁, then C₂, then C₃, and then C₄, with C₁ indicating the first color and C₂, C₃, C₄ indicating other colors. The shifting lighting pattern includes repeating the sequence, e.g., C₁-C₂-C₃-C₄-C₁-C₂-C₃-C₄-C₁-C₂-C₃-C₄ and so on until the computer 105 changes the lighting pattern. Each color in the sequence has a corresponding time duration over which the color is emitted, and the time durations for different colors may be different. For example, the time duration T₁ to emit the first color C₁ may be longer than the time duration T₂ for at least one of the other colors C₂, e.g., longer than any of the time durations T₂, T₃, T₄ for the other colors C₂, C₃, C₄, respectively, e.g., T₁>T₂=T₃=T₄. The unequal time durations can emphasize the autonomous capability of the vehicle 100.

The shifting lighting pattern may include fading between colors of the plurality of colors in the sequence, i.e., decreasing the quantity of a previous color while increasing the quantity of a next color over a sufficient time duration to be perceptible to another road user viewing the vehicle 100. Fading between colors provides a subtle way to notify other road users. For example, over the time duration, the quantity of the previous color may linearly decrease from 100% to 0%, and the quantity of the next color may linearly increase from 0% to 100%, e.g., as in the following expression for two colors C₁, C₂:

$$C ( t ) = \{ \begin{matrix}{C}_{1} & 0 < t < {T}_{1} \\ {C}_{1} + \frac{{C}_{2} - {C}_{1}}{{T}_{f}} ( t - {T}_{1} ) & {T}_{1} < t < {T}_{1} + {T}_{f} \\ {C}_{2} & {T}_{1} + {T}_{f} < t < {T}_{1} + {T}_{2} + {T}_{f} \\ {C}_{2} + \frac{{C}_{1} - {C}_{2}}{{T}_{f}} ( t - ( {T}_{1} + {T}_{2} + {T}_{f} ) ) & {T}_{1} + {T}_{2} + {T}_{f} < t < {T}_{1} + {T}_{2} + 2 {T}_{f}\end{matrix}$$

in which T_{f} is the time duration for fading between two colors.

The computer 105 is programmed to actuate the lamp 110, 115 to emit light following the shifting lighting pattern according to at least one inputted parameter. The operator may input the parameters for the shifting lighting pattern as described above. Possible parameters include selections of one or more colors beyond the first color (e.g., choice of C₂, C₃, C₄, etc.), the time duration T_{f} of fading between consecutive colors, a total number of colors in the sequence, the time durations Tᵢ for emitting the respective colors (in which i is an index of the colors), etc. The options for each parameter may be circumscribed. For example, the total number of colors must be at least two, the time durations Tᵢ for emitting the colors must be shorter than the time duration T₁ for emitting the first color, etc.

The trigger for the shifting lighting pattern may be that the speed at which the vehicle 100 is traveling is below the threshold speed. In other words, the computer 105 is programmed to, in response to the speed at which the vehicle 100 is traveling being below the threshold speed, actuate the lamp 110, 115 to emit light following the shifting lighting pattern according to the inputted parameter(s). The trigger for the shifting lighting pattern may be satisfied regardless of whether the vehicle 100 is in the autonomous mode or the nonautonomous mode, or the trigger for the shifting lighting pattern may further include that the vehicle 100 is in the autonomous mode.

The computer 105 is programmed to actuate the lamp 110, 115 to emit light following the nonautonomous lighting pattern. The nonautonomous lighting pattern is different than the shifting lighting pattern and different than the solid lighting pattern (i.e., different than continuously emitting the first color). For example, the nonautonomous lighting pattern may be to actuate the lamp 110, 115 to continuously emit a single color different than the first color. The selection of the color may be an inputted parameter, with the first color not being an option. For another example, the nonautonomous lighting pattern may include cycling through a plurality of colors excluding the first color, with or without fading between the colors. The selections of at least some of the colors may be inputted parameters, with the first color not being an option. If fading is used, the time duration to fade between colors may be an inputted parameter.

The trigger for the nonautonomous lighting pattern may be that the vehicle 100 is in the nonautonomous mode. In other words, the computer 105 is programmed to, in response to the vehicle 100 being in the nonautonomous mode, actuate the lamp 110, 115 to follow the nonautonomous lighting pattern. The trigger for the nonautonomous lighting pattern may be satisfied regardless of whether the speed at which the vehicle 100 is traveling is above or below the speed threshold.

The computer 105 may be programmed to actuate the lamp 110, 115 to emit light following a welcome lighting pattern. The welcome lighting pattern is different than the shifting lighting pattern and different than the solid lighting pattern (i.e., different than continuously emitting the first color). For example, the welcome lighting pattern may be to actuate the lamp 110, 115 to continuously emit a single color different than the first color. The selection of the color may be an inputted parameter, with the first color not being an option. For another example, the welcome lighting pattern may include cycling through a plurality of colors excluding the first color, with or without fading between the colors. The selection of at least some of the colors may be inputted parameters, with the first color not being an option. If fading is used, the time duration to fade between colors may be an inputted parameter. The welcome lighting pattern may also be different than the nonautonomous lighting pattern, e.g., a single color rather than cycling between colors, or a different set of colors for cycling between colors.

The trigger for the welcome lighting pattern may be that the vehicle 100 has shifted into park. For example, a gear of the vehicle 100 may shift from drive, reverse, or neutral into park. In other words, the computer 105 is programmed to, in response to the vehicle 100 shifting into park, actuate the lamp 110, 115 to follow the welcome lighting pattern. The trigger for the welcome lighting pattern may further include that the vehicle 100 is at a prespecified location, e.g., a pickup location for a ride-hailing trip.

The computer 105 may be programmed to actuate the lamp 110, 115 to emit light following the strobe lighting pattern. The strobe lighting pattern includes repeatedly actuating the lamp 110, 115 on and off. The strobe lighting pattern may be to actuate the lamp 110, 115 to emit a single color, but intermittently rather than continuously as in the solid lighting pattern. Alternatively, the strobe lighting pattern may be to cycle through a sequence of colors as the lamp 110, 115 turns on and off, e.g., the lamp 110, 115 actuates to emit a next color in the sequence each time that the lamp 110, 115 turns back on. A rate of actuating the lamp 110, 115 on and off in the strobe lighting pattern may be faster than a rate of switching colors in the shifting lighting pattern, e.g., T_{strobe}<Tᵢ for all i, in which T_{strobe} is the time from turning the lamp 110, 115 on to the next time turning the lamp 110, 115 on. The strobe lighting pattern may thus be more noticeable than the shifting lighting pattern.

The trigger for the strobe lighting pattern may be that the vehicle 100 is decelerating and that the speed at which the vehicle 100 is traveling is within a threshold difference of the speed threshold. In other words, the computer 105 is programmed to, in response to the vehicle 100 decelerating and the speed at which the vehicle 100 is traveling being within the threshold difference of the speed threshold, actuate the lamp 110, 115 to emit light following the strobe lighting pattern. The vehicle 100 decelerating means that the speed at which the vehicle 100 is traveling is decreasing, i.e., \dot{v}<0, in which v is the speed at which the vehicle 100 is traveling and the dot indicates a derivative with respect to time. The threshold difference may be above the speed threshold, i.e., v_{T}<v<v_{T}+v_{diff}, in which vy is the speed threshold and v_{diff}is the threshold difference. Alternatively, the threshold difference may be below the speed threshold, i.e., v_{T}−v_{diff}<v<v_{T}, or the threshold difference may be above and below the speed threshold, i.e., v_{T}−v_{diff}<v<v_{T}+v_{diff}: The threshold difference may be chosen to indicate that the speed v is close to the speed threshold v_{T}, e.g., v_{diff}=3 miles per hour.

One or more of the lamp units 205 may also be used for outputting traffic signals for the vehicle 100, in addition to the lighting patterns above. The term “traffic signals” refers to indications of current or intended maneuvers by the vehicle 100, e.g., that the vehicle 100 is braking or that a turn indicator is active. When a traffic signal is present for the vehicle 100, the traffic signal may override the lighting pattern for one of the lamps 110, 115, e.g., the second lamp 115, or for both lamps 110, 115. The traffic signal can override whichever lighting pattern is selected according to the triggers above, e.g., the solid lighting pattern, the shifting lighting pattern, etc. In other words, the computer 105 is programmed to, in response to one of braking or an active turn indicator of the vehicle 100, actuate one or both lamps 110, 115 to indicate the braking or the active turn indicator, e.g., by emitting solid red for braking or blinking amber or red for an active turn indicator. If only one lamp 110, 115 is actuated for the traffic signal, the computer 105 may actuate the remaining lamp 110, 115, e.g., the first lamp 110, according to the lighting pattern selected above.

Whether one or both lamps 110, 115 are overridden for a traffic signal may depend on a vehicle state. For example, the computer 105 may override both lamps 110, 115 for braking while the vehicle 100 is in motion, i.e., v≠0, and the computer 105 may override the second lamp 115 for braking while the vehicle 100 is fully stopped, i.e., v=0. When the vehicle 100 is braked and fully stopped, the computer 105 may actuate the first lamp 110 to emit light following the lighting pattern selected above.

The computer 105 may be programmed to actuate both lamps 110, 115 to emit light following the same lighting pattern when there is not a traffic signal. In other words, the computer 105 may be programmed to, in response to an absence of the one of the braking or the active turn indicator of the vehicle 100, actuate both lamps 110, 115 to emit light following the lighting pattern selected according to the triggers above, i.e., to actuate the second lamp 115 following a same pattern as the first lamp 110.

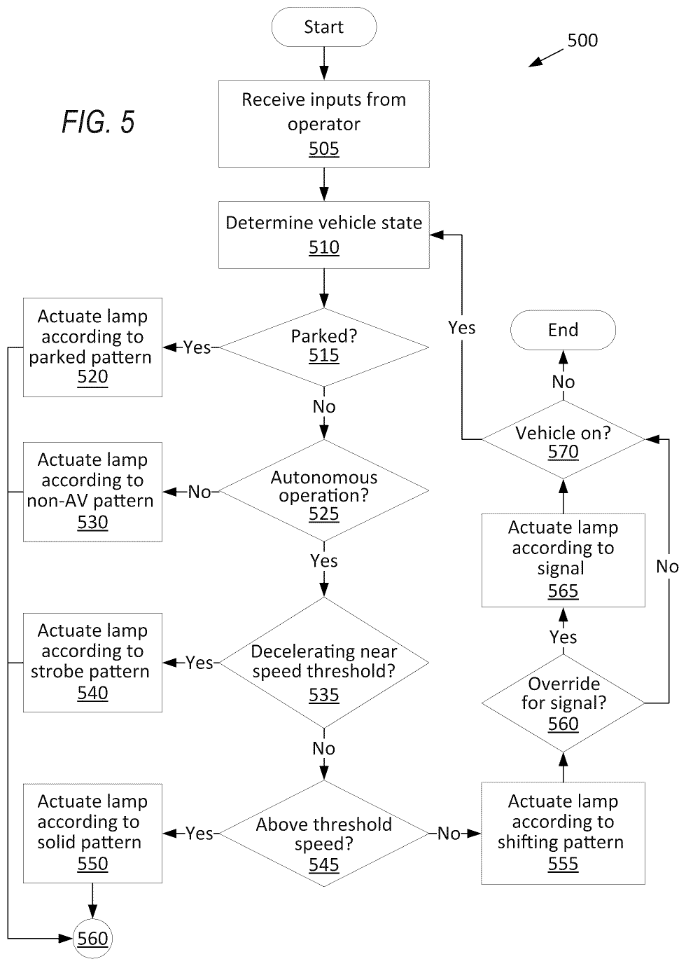

FIG. 5 is a flowchart illustrating an example process 500 for actuating one of the lamp units 205. The memory of the computer 105 stores executable instructions for performing the steps of the process 500 and/or programming can be implemented in structures such as mentioned above. The process 500 may begin in response to the vehicle 100 starting. As a general overview of the process 500, the computer 105 receives the inputs from the operator and determines a state of the vehicle 100. The computer 105 actuates the lamps 110, 115 following the welcome lighting pattern in response to the vehicle 100 being in park, following the nonautonomous lighting pattern in response to the vehicle 100 being in the autonomous mode, following the strobing pattern in response to the vehicle 100 decelerating and the speed at which the vehicle 100 is traveling being within the threshold difference of the speed threshold, following the solid pattern in response to the speed at which the vehicle 100 is traveling exceeding the speed threshold and the vehicle 100 being in the autonomous mode, and following the shifting lighting pattern in response to the speed at which the vehicle 100 is traveling being below the speed threshold. The computer 105 overrides the lighting pattern for one or both lamps 110, 115 in response to the vehicle 100 having a traffic signal. The process 500 continues for as long as the vehicle 100 remains on.

The process 500 begins in a block 505, in which the computer 105 receives the inputs from the operator setting the parameters, as described above.

Next, in a block 510, the computer 105 determines the state of the vehicle 100, e.g., the speed at which the vehicle 100 is traveling, the autonomous or nonautonomous mode of the vehicle 100, the gear of the vehicle 100, whether the vehicle 100 is accelerating or decelerating, as described above.

Next, in a decision block 515, the computer 105 determines whether the vehicle 100 is in park, i.e., whether the gear of the vehicle 100 is park, as described above. In response to the vehicle 100 shifting into park, the process 500 proceeds to a block 520. Otherwise, the process 500 proceeds to a decision block 525.

In the block 520, the computer 105 actuates the lamps 110, 115 to emit light following the welcome lighting pattern, as described above. After the block 520, the process 500 proceeds to a decision block 560.

In the decision block 525, the computer 105 determines whether the vehicle 100 is in the autonomous mode, as described above. In response to the vehicle 100 being in the nonautonomous mode, the process 500 proceeds to a block 530. In response to the vehicle 100 being in the autonomous mode, the process 500 proceeds to a decision block 535.

In the block 530, the computer 105 actuates the lamps 110, 115 to emit light following the nonautonomous lighting pattern, as described above. After the block 530, the process 500 proceeds to the decision block 560.

In the decision block 535, the computer 105 determines whether the vehicle 100 is decelerating and the speed at which the vehicle 100 is traveling is within the threshold difference of the speed threshold, as described above. In response to the vehicle 100 decelerating and the speed at which the vehicle 100 is traveling being within the threshold difference of the speed threshold, the process 500 proceeds to a block 540. In response to either the vehicle 100 not decelerating or the speed at which the vehicle 100 is traveling being outside the threshold difference from the speed threshold, the process 500 proceeds to a decision block 545.

In the block 540, the computer 105 actuates the lamps 110, 115 to emit light following the strobe lighting pattern, as described above. After the block 540, the process 500 proceeds to the decision block 560.

In the decision block 545, the computer 105 determines whether the speed at which the vehicle 100 is traveling exceeds the speed threshold. In response to the speed at which the vehicle 100 is traveling exceeding the speed threshold, the process 500 proceeds to a block 550. In response to the speed at which the vehicle 100 is traveling being below the threshold speed, the process 500 proceeds to a block 555.

In the block 550, the computer 105 actuates the lamps 110, 115 to emit light following the solid lighting pattern, as described above. After the block 550, the process 500 proceeds to the decision block 560.

In the block 555, the computer 105 actuates the lamps 110, 115 to emit light following the shifting lighting pattern according to the inputted parameters from the block 505, as described above. After the block 555, the process 500 proceeds to the decision block 560.

In the decision block 560, the computer 105 determines whether the vehicle 100 currently has a traffic signal, e.g., whether the vehicle 100 is braking or has an active turn indicator. In response to one of braking or an active turn indicator of the vehicle 100, the process 500 proceeds to a block 565. In response to the absence of braking or an active turn indicator, the process 500 proceeds to a decision block 570, thereby leaving the lamps 110, 115 to actuate following the selected lighting pattern from the block 520, 530, 540, 550, or 555.

In the block 565, the computer 105 actuates one or both of the lamps 110, 115 to indicate the braking or the active turn indicator, as described above. After the block 565, the process 500 proceeds to the decision block 570.

In the decision block 570, the computer 105 determines whether the vehicle 100 is still on, i.e., is still in an on state. For the purposes of this disclosure, “on state” is defined as the state of the vehicle 100 in which full electrical energy is provided to electrical components of the vehicle 100 and the vehicle 100 is ready to be driven, e.g., the engine is running; “off state” is defined as the state of the vehicle 100 in which a low amount of electrical energy is provided to selected electrical components of the vehicle 100, typically used when the vehicle 100 is being stored; and “accessory-power state” is defined as the state of the vehicle 100 in which full electrical energy is provided to more electrical components than in the off state and the vehicle 100 is not ready to be driven. Typically, an operator puts the vehicle 100 into the on state when the operator is going to operate the vehicle 100, puts the vehicle 100 into the off state when the operator is going to leave the vehicle 100, and puts the vehicle 100 into the accessory-power state when the operator is going to sit in but not operate the vehicle 100. In response to the vehicle 100 being in the on state, the process 500 returns to the block 510 to update the vehicle 100 state and re-select the lighting pattern. In response to the vehicle 100 being in the off state or the accessory-power state, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™M, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
receive an input from an operator of a vehicle, the input setting a parameter for a shifting lighting pattern of a lamp of the vehicle, the shifting lighting pattern including cycling through a plurality of colors including a first color;
in response to a speed at which the vehicle is traveling exceeding a speed threshold and the vehicle being in an autonomous mode, actuate the lamp to continuously emit the first color; and
in response to the speed at which the vehicle is traveling being below the threshold speed, actuate the lamp to emit light following the shifting lighting pattern according to the inputted parameter.

2. The computer of claim 1, wherein the plurality of colors of the shifting lighting pattern includes a second color, and the inputted parameter is a selection of the second color.

3. The computer of claim 1, wherein the shifting lighting pattern includes fading between colors of the plurality of colors in a sequence, and the inputted parameter is a time duration of the fading between consecutive colors of the sequence.

4. The computer of claim 1, wherein the shifting lighting pattern includes repeating a sequence of the plurality of the colors, and a time duration to emit the first color is longer than a time duration to emit a second color of the plurality of colors.

5. The computer of claim 4, wherein the time duration to emit the first color is longer than any time duration of any other color of the plurality of colors.

6. The computer of claim 1, wherein the instructions further include instructions to, in response to the vehicle decelerating and the speed at which the vehicle is traveling being within a threshold difference of the speed threshold, actuate the lamp to emit light following a strobe lighting pattern.

7. The computer of claim 6, wherein the strobe lighting pattern includes repeatedly actuating the lamp on and off.

8. The computer of claim 7, wherein a rate of actuating the lamp on and off in the strobe lighting pattern is faster than a rate of switching colors in the shifting lighting pattern.

9. The computer of claim 1, wherein the instructions further include instructions to, in response to the vehicle shifting into park, actuate the lamp to emit light following a first lighting pattern, the first lighting pattern being different than the shifting lighting pattern and different than continuously emitting the first color.

10. The computer of claim 1, wherein the instructions further include instructions to, in response to one of braking or an active turn indicator of the vehicle, actuate the lamp to indicate the braking or the active turn indicator.

11. The computer of claim 10, wherein actuating the lamp to indicate the braking or the active turn indicator overrides the shifting lighting pattern.

12. The computer of claim 1, wherein the instructions further include instructions to, in response to the vehicle being in a nonautonomous mode, actuate the lamp to emit light following a first lighting pattern, the first lighting pattern being different than the shifting lighting pattern and different than continuously emitting the first color.

13. The computer of claim 1, wherein the lamp is a first lamp, and the instructions further include instructions to, in response to one of braking or an active turn indicator of the vehicle, actuate a second lamp to indicate the braking or the active turn indicator, the second lamp being in a same housing as the first lamp.

14. The computer of claim 13, wherein the instructions further include instructions to, in response to an absence of the one of the braking or the active turn indicator of the vehicle, actuate the second lamp following a same pattern as the first lamp.

15. The computer of claim 1, wherein the first color is turquoise.

16. A method comprising:
receiving an input from an operator of a vehicle, the input setting a parameter for a shifting lighting pattern of a lamp of the vehicle, the shifting lighting pattern including cycling through a plurality of colors including a first color;
in response to a speed at which the vehicle is traveling exceeding a speed threshold and the vehicle being in an autonomous mode, actuating the lamp to continuously emit the first color; and
in response to the speed at which the vehicle is traveling being below the threshold speed, actuating the lamp to emit light following the shifting lighting pattern according to the inputted parameter.

17. The method of claim 16, wherein the plurality of colors of the shifting lighting pattern includes a second color, and the inputted parameter is a selection of the second color.

18. The method of claim 16, wherein the shifting lighting pattern includes fading between consecutive colors of the plurality of colors, and the inputted parameter is a time duration of the fading between consecutive colors.

19. The method of claim 16, wherein the shifting lighting pattern includes repeating a sequence of the plurality of the colors, and a time duration to emit the first color is longer than a time duration to emit a second color of the plurality of colors.

20. The method of claim 16, wherein the lamp is a first lamp, the method further comprising:
in response to one of braking or an active turn indicator of the vehicle, actuating a second lamp to indicate the braking or the active turn indicator, the second lamp being in a same housing as the first lamp; and
in response to an absence of the one of the braking or the active turn indicator of the vehicle, actuating the second lamp following a same pattern as the first lamp.
